(19) United States
(12) Patent Application Publication
(10) Pub. No.: US 2022/0241842 A1
(43) Pub. Date: Aug. 4, 2022

(54) FASTENER DELIVERY APPARATUS

(71) Applicant: Atlas Copco IAS UK Limited, Flintshire, Wales (GB)

(72) Inventor: Fred Galvin, Ewloe Flintshire (GB)

(21) Appl. No.: 17/620,323

(22) PCT Filed: Jun. 15, 2020
(86) PCT No.: PCT/EP2020/066520

§ 371 Date: Dec. 17, 2021

(30) Foreign Application Priority Data
Jun. 21, 2019 (GB) 1908900.2

(51) Int. Cl. B21J 15/02; B21J 15/32

(52) U.S. Cl. CPC B21J 15/025; B21J 15/32

(57) ABSTRACT

A fastener delivery apparatus comprising a nose assembly configured to convey a fastener towards a workpiece, the nose assembly comprising a barrel and a fastener alignment device; wherein the barrel comprises a bore having a longitudinal axis and a distal end for engaging the workpiece; an actuator configured to urge the fastener through the bore; wherein the fastener alignment device comprises a plurality of resilient arms which extend towards the distal end of the barrel; wherein at least part of each of the plurality of resilient arms projects into the bore via apertures in the barrel; wherein the plurality of resilient arms are biased radially inwards to engage the fastener; and wherein the resilient arms are configured such that at a maximum deflection, the resilient arms do not pass beyond the periphery of the barrel.

### FIELD OF INVENTION

This invention relates to fastener delivery apparatus

### BACKGROUND

The term “fastener” is used herein to include rivets, screws, slugs, weld studs, mechanical studs and other types of fastening devices.

Known fastener delivery apparatus include a nose assembly into which a fastener is passed from a fastener storage location, and from which the fastener is inserted into a workpiece by an actuator. The nose assembly includes a central bore through which the fastener and the actuator travel before the fastener is inserted into the workpiece.

The nose assembly further includes a fastener alignment device provided adjacent a distal end of the central bore. The fastener alignment device acts to prevent the fastener from falling out of the nose assembly. The fastener alignment device may for example comprise a plurality of balls or rollers which are resiliently biased towards the central bore such that they engage with the fastener when the fastener reaches a bottom end of the nose assembly. In addition to preventing the fastener from falling from the nose assembly, the balls or rollers assist in ensuring that the fastener has a desired orientation and is centralised in the central bore before the fastener is inserted into a workpiece.

It is desirable to be able to fasten workpieces together in a variety of different locations. It may for example be desirable to fasten together flanges which project from an object (for example a gutter which projects from a door window of a car) or some other workpiece which is located adjacent to an obstacle. A fastener insertion apparatus may be unable to fasten the workpiece unless the workpiece projects from the obstacle by a distance which is at least equal to (or substantially equal to) the diameter of the nose assembly of the fastener insertion apparatus.

It is desirable to provide a fastener delivery apparatus having a nose assembly which is narrower in at least one direction compared with at least some known prior art fastener delivery apparatus.

### SUMMARY

A first aspect of the present invention relates to a fastener delivery apparatus. The fastener delivery apparatus comprises a nose assembly configured to convey a fastener towards a workpiece, the nose assembly comprising a barrel and a fastener alignment device. The barrel comprises a bore having a longitudinal axis and a distal end for engaging the workpiece. The fastener delivery apparatus further comprises an actuator configured to urge the fastener through the bore. The fastener alignment device comprises a plurality of resilient arms which extend towards the distal end of the barrel. At least part of each of the plurality of resilient arms projects into the bore via apertures in the barrel. The plurality of resilient arms are biased radially inwards to engage the fastener. The resilient arms are configured such that at a maximum deflection, the resilient arms do not pass beyond the periphery of the barrel.

Conventional nose assemblies typically comprise a volume or cavity located between the bore of the barrel and the external surface of the barrel which houses a fastener alignment device. Such assemblies typically retain and/or align the fastener by utilising a biasing member which engages the inside wall of the volume or cavity. The provision of this volume or cavity requires that the wall thickness of the barrel (i.e. the external surface of the barrel less the bore of the barrel) is sufficiently thick such that it can accommodate the fastener alignment device. Advantageously, the present invention utilises resilient arms which extend towards the distal end of the barrel and project into the central bore of the barrel via apertures in the barrel. The resilient arms are themselves resilient and so act as leaf springs and do not require in internal surface to engage in order to provide a biasing force which acts radially inwards. Therefore, the barrel need not comprise an internal volume, and the outside diameter of the barrel can be reduced. This makes the barrel more space efficient compared to known barrel assemblies. In addition the present invention can be used in regions of a workpiece that would otherwise be inaccessible.

Fastener delivery apparatus have a required working space. The required working space may be understood to mean the maximum space occupied by the apparatus at any point during operation of the apparatus. This may be because, for example, components which do not protrude during one operation can often protrude during a different operation. Advantageously, by providing a fastener alignment device which does not pass beyond the periphery of the barrel, the required working space of the barrel is minimised. Minimising the required working space of fastener delivery apparatus is desirable because it allows access to regions of a workpiece that may otherwise be inaccessible.

In some embodiments, in a rest state at least part of the plurality of resilient arms are located against an external surface of the barrel thereby defining the position of the plurality of resilient arms when the plurality of resilient arms are in the rest state.

Known fastener alignment devices are typically located within an internal cavity and so are located against internal surfaces of the barrel. This results in a large barrel diameter, as discussed above. The fastener alignment device of the present invention is located externally on the barrel and so the barrel does not require an internal cavity to house the fastener alignment device.

In some embodiments, the nose assembly comprises an adaptor which receives the barrel, and wherein a portion of the fastener alignment device is held between the barrel and the adaptor.

When the fastener alignment device is deflected to as to allow a fastener to pass through, the fastener alignment device requires a surface against which it can exert a load in order to satisfy Newton's third law. Advantageously, holding the fastener alignment device between a nose adaptor and the barrel grips the fastener alignment device in an axial direction (i.e. parallel to the longitudinal axis of the bore), and so provides the required surface in a space efficient manner. It will be appreciated that other methods and/or components can be used to provide the fastener alignment device with the required surface.

In some embodiments, the inclusive angle of the resilient arms with respect to an axis perpendicular to the longitudinal axis at the maximum deflection is less than 90 degrees.

Advantageously, this ensures that the resilient arms do not pass beyond the periphery of the barrel, therefore resulting in a more space efficient nose assembly.

In some embodiments, at zero deflection the angle of the resilient arms with respect to an axis perpendicular to the longitudinal axis of the barrel is between about 72.5 degrees and about 81.5 degrees. In other embodiments, at zero deflection the angle of the resilient arms with respect to an axis perpendicular to the longitudinal axis of the barrel is between about 72.5 degrees and about 77.5 degrees In other embodiments, at zero deflection the angle of the resilient arms with respect to an axis perpendicular to the longitudinal axis of the barrel is between about 76 degrees and about 81.5 degrees.

Advantageously, this range of angles allows the resilient arms to engage the fastener while not deflecting beyond the periphery of the barrel when at maximum deflection.

In some embodiments, the fastener alignment device further comprises an annular member and wherein each of the plurality of resilient arms is connected to the annular member.

In some embodiments, the resilient arms deflect radially outwards when the fastener is urged through the bore by the actuator and allow passage of the fastener out of the bore.

In some embodiments, the fastener alignment device further comprises a plurality of fastener engaging members which are affixed to distal ends of each of the plurality of resilient arms.

Advantageously, the fastener engaging members can improve the ability of the fastener alignment device to engage the fasteners passing through the bore.

In some embodiments, the fastener engaging members comprise offset hemispheres.

Offset hemispheres may be understood to mean a hemisphere which that the hemisphere has been adjusted such that a slice of the hemisphere parallel to the flat surface of the hemisphere has been removed.

Advantageously, this allows the required working space of the fastener delivery apparatus to be reduced whilst maintaining smooth passage of the fastener through the fastener alignment device. Offset hemispheres reduce the maximum deflection because the fastener engaging members do not protrude as far into the central bore compared to non-offset hemispheres.

In some embodiments, the fastener is a rivet.

In some embodiments, the plurality of resilient arms comprises three resilient arms. Advantageously, this allows the fastener to be coaxial with the central bore of the barrel. This helps to ensure that the fastener is correctly inserted into the workpiece.

A second aspect of the invention relates to a method of delivering a fastener to a workpiece. The method comprises moving a fastener through a bore of a barrel of a fastener delivery apparatus, gripping at least part of the fastener with a fastener alignment device. The fastener alignment device comprises a plurality of resilient arms which extend towards a distal end of the barrel. At least part of each of the plurality of resilient arms project into the bore of the barrel via apertures in the barrel. The method further comprises driving the fastener with an actuator. Driving of the fastener results in the resilient arms being deflected radially outwards so as to permit passage of the fastener past the fastener alignment device and out of the barrel. At maximum deflection, the plurality of the resilient arms do not pass beyond the periphery of the barrel.

In some embodiments, in a rest state at least part of the plurality of resilient arms are located against an external surface of the barrel thereby defining the position of the plurality of resilient arms when the plurality of resilient arms are in the rest state.

In some embodiments, the nose assembly comprises an adaptor which receives the barrel, and wherein a portion of the fastener alignment device is held between the barrel and the adaptor.

In some embodiments, the inclusive angle of the resilient arms with respect to an axis perpendicular to the longitudinal axis at the maximum deflection is less than 90 degrees.

In some embodiments, at zero deflection the angle of the resilient arms with respect to an axis perpendicular to the longitudinal axis of the barrel is between about 72.5 degrees and about 81.5 degrees. In other embodiments, at zero deflection the angle of the resilient arms with respect to an axis perpendicular to the longitudinal axis of the barrel is between about 72.5 degrees and about 77 degrees. In other embodiments, at zero deflection the angle of the resilient arms with respect to an axis perpendicular to the longitudinal axis of the barrel is between about 76 degrees and about 81.5 degrees.

In some embodiments, the fastener alignment device further comprises an annular member and wherein each of the plurality of resilient arms is connected to the annular member.

In some embodiments, the resilient arms deflect radially outwards when the fastener is urged through the bore by the actuator and allow passage of the fastener out of the bore.

In some embodiments, the fastener alignment device further comprises a plurality of fastener engaging members which are affixed to distal ends of each of the plurality of resilient arms.

In some embodiments, the fastener engaging members comprise offset hemispheres.

In some embodiments, the fastener is a rivet.

In some embodiments, the plurality of resilient arms comprises three resilient arms.

Features disclosed with respect to one aspect of the invention may also be combined with other aspects of the invention.

### BRIEF DESCRIPTION OF THE DRAWINGS

The present invention will now be described with reference to the following figures, in which:

FIG. 1 is a cross-sectional view of a fastener delivery apparatus according to an embodiment of the invention including a fastener retention device in an undeflected state;

FIG. 2 is a perspective view of the fastener retention device of FIG. 1;

FIG. 3 is a perspective view of a fastener engaging component of the fastener retention device;

FIG. 4 is a perspective view of a barrel of the fastener retention device;

FIG. 5 is a cross-sectional view of the with the fastener retention device in an intermediate state;

FIG. 6 depicts in cross-section the fastener delivery apparatus with the fastener retention device at maximum deflection;

FIG. 7 depicts a perspective view of a modified fastener retention device; and

FIG. 8 depicts a fastener insertion apparatus.

### DETAILED DESCRIPTION

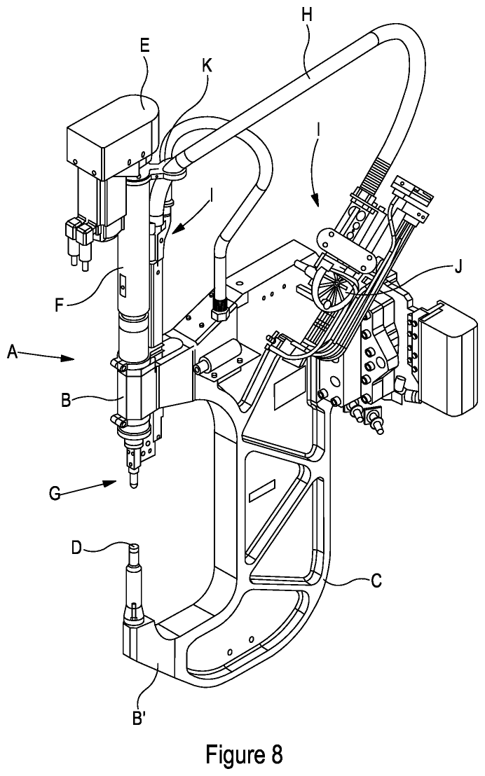

Referring to FIG. 8, a fastener insertion apparatus typically comprises a rivet setting tool A that is supported by an upper jaw B of a C-frame C above a fastener-upsetting die D disposed on a lower jaw B′ of the frame. Rivets are inserted by the tool into a workpiece (not shown) supported over the die D as is well known in the art.

The setting tool A may comprise an electric drive E (other types of drive such as hydraulic or pneumatic can be used) that operates to drive a reciprocal actuator (which may be referred to as a punch and is not visible in the figure) in a cylindrical housing F and a nose assembly G. Rivets are loaded into the nose assembly G for insertion into the workpiece by the actuator. Rivets may be supplied under air or gas pressure from a bulk feeder (not shown) via a delivery tube H that is releasably connectable to the rivet insertion apparatus via a docking station I. One half of the docking station I is connected to the end of the delivery tube H and the other half, being supported on a robot mounting plate, is connected to the inlet of a buffer magazine J. Supplied rivets are intermittently loaded into the buffer magazine and then fed individually to the setting tool via an escapement mechanism and a (flexible) supply tube. A ring proximity sensor K detects the passage of a rivet in the tube. The rivets are delivered to the actuator via a nose assembly feeder assembly L that is mounted immediately adjacent to the nose assembly G. Once delivered to the actuator, the rivets can be engaged by the actuator and travel through the nose assembly G and into the workpiece. The present invention is concerned with the configuration of the nose assembly.

As a non-depicted alternative to the rivets being supplied via a first delivery tube using air or gas pressure, the rivets may be supplied using a web, which may be referred to as tape. The tape may for example be formed from plastic, and may include flanges which may assist in providing stability to the web and may assist guiding the web through a section which is cut into the nose assembly. The actuator is used to drive rivets out of the tape, through the nose assembly and into a workpiece.

In use, the web is moved through the section until a rivet is located beneath the actuator. The actuator is then moved downwards through web, thereby pushing the rivet from the web and into the central bore of the nose assembly. The rivet is held in a desired orientation by a fastener alignment device (as described further below) at a bottom end of the nose assembly. The actuator engages the rivet and pushes the rivet from the nose assembly into a workpiece. The actuator is then withdrawn from the nose assembly and the web. The web is then moved until a new rivet is located beneath the actuator, whereupon operation of the apparatus is repeated.

Once the fastener has been engaged by the actuator in either of the above methods, the present invention operates in generally the same way. Therefore, the below disclosure is applicable to both methods.

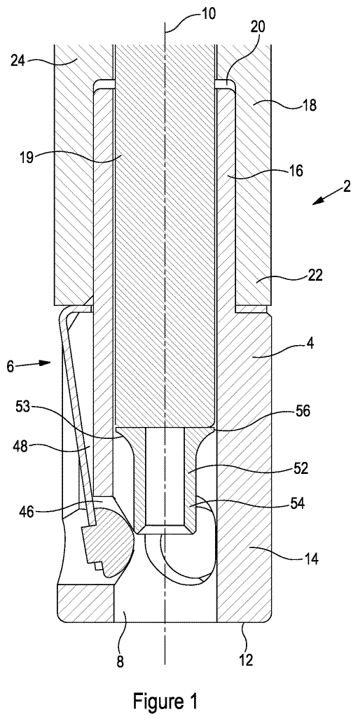

Referring now to FIG. 1, a nose assembly 2 in accordance with an embodiment of the present invention is depicted. The nose assembly 2 comprises a barrel 4 and a fastener retention device 6.

The barrel 4 comprises a central bore 8 having a longitudinal axis 10 and a flat distal end 12 for engaging a workpiece (not shown). The central bore 8 of the barrel may or may not be of uniform diameter. The barrel 4 comprises a distal section 14 and a proximal section 16. The outside diameter of the distal section 14 may be greater than the outside diameter of the proximal section 16. In the depicted embodiment, the proximal section 16 of the barrel 4 is received by an adaptor 18. It will be appreciated that the barrel 4 does not necessarily have a circular outer surface in cross-section. The outer surface of the barrel 4 may be, square, pentagonal, hexagonal or any other suitable shape in cross-section.

The adaptor 18 comprises a central bore 20 which is coaxial with the bore 8 of the barrel 4. The adaptor 18 comprises a distal section 22 and a proximal section 24. In the depicted embodiment, the diameter of the central bore 20 of the adaptor 18 is greater in the distal section 22 than in the proximal section 24. The diameter of the bore 20 in the distal section 22 may generally correspond to the outside diameter of the proximal section 16 of the barrel 4. This allows the proximal section 16 of the barrel 4 to be received by the adaptor 18. As discussed above, the central bore 8 of the adaptor 18 is not of uniform diameter. However, in other embodiments, to the contrary, the central bore of the adapter may be of uniform diameter.

In a non-depicted alternative to the above, the inside diameter of the proximal section 16 of the barrel 4 may generally correspond with the outside diameter of the distal section 22 of the adaptor 18. Therefore, the distal section 22 of the adaptor 18 may be received by the proximal section 16 of the barrel 4. The methods described below for fixing the barrel 4 to the adaptor 18 apply to this embodiment with the appropriate changes made as needed.

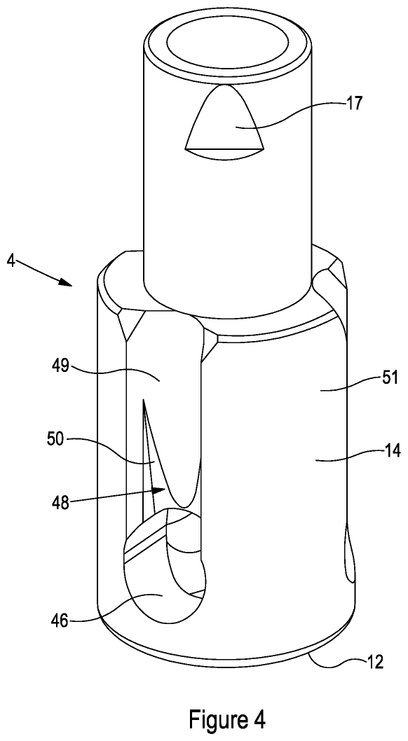

The barrel 4 may be secured to the adaptor 18 by any suitable means. In the depicted embodiment, the distal section 22 of the adaptor 18 comprises a radial threaded aperture (not shown). A fastener (not shown), e.g. a grub screw or bolt, may then be inserted into the radial threaded aperture and engage the proximal section 16 of the barrel 4. This results in friction between the fastener and the proximal section 16 of the barrel 4, thereby fixing the position of the barrel 4 with respect to the adaptor 18. The barrel 4 may comprise a flat section 17, known in the art as a whistle flat. The flat section 17 is located at the proximal section 16 of the barrel 4, as can be seen in FIG. 4. The flat section 17 may be engaged by the above-mentioned fastener and allow the load provided by the fastener to be more evenly distributed by virtue of the contact area between the fastener and the adaptor 4 (compared to if the fastener were to engage a non-planar surface). In addition, the flat surface 17 is angled towards the central axis 10 of the bore 8 of the barrel 4. This prevents axial movement of the barrel 4 with respect to the adaptor 18 and therefore contributes to the retention of the barrel inside the adaptor.

Alternatively, in a non-depicted embodiment, the barrel 4 may be received by the bore 20 of the adaptor 18 via an interference fit. Further alternatively, in a non-depicted embodiment, the central bore 20 of the adaptor 18 may be threaded and the outside diameter of the proximal section 16 of the barrel 4 may be threaded, allowing the barrel 4 to be threaded to the adaptor 18. Further alternatively, in a non-depicted embodiment, the barrel 4 may be adhered to the central bore 20 of the adaptor 18 by virtue of a suitable adhesive. The adaptor and barrel may be made of any suitable material, for example hardened steel.

As noted above, the central bore 20 of the adaptor 18 and the bore 8 of the barrel 4 are coaxial. This allows the passage of an actuator 19 through the central bore 20 of the adaptor 18 and through the central bore 8 of the barrel 4. As discussed above, rivets are presented for engagement by the actuator 19. Once the rivet has been engaged by the actuator 19, the rivet and the actuator 19 travel through the central bore 20 of the adaptor 18 and through the central bore 8 of the barrel 4, as will be discussed in more detail below.

Whilst the presently described embodiment includes a separate barrel which is received by an adaptor, in other embodiments the barrel and adaptor may be one-piece.

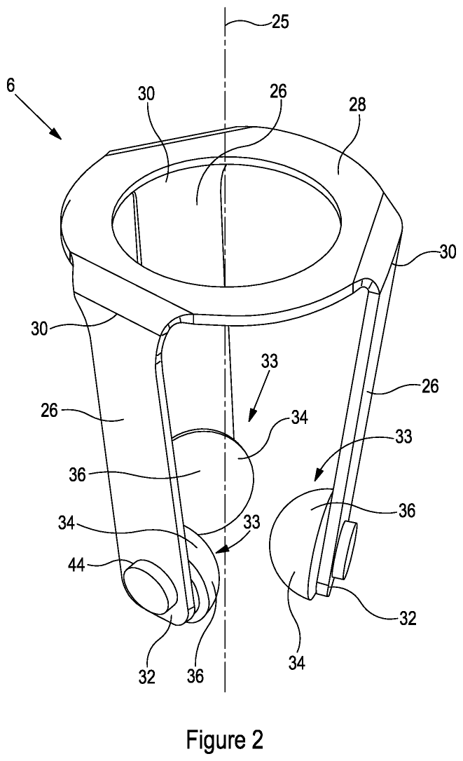

As noted above, the nose assembly 2 comprises a fastener retention device 6, which is best seen in FIG. 2. The fastener retention device 6 is provided so as to prevent a rivet which is to be inserted into a workpiece from simply falling out of the central bore 8 of the barrel 4. The fastener retention device is also provided so as to provide a rivet with a desired orientation and alignment with respect to the longitudinal axis 10 of the barrel 4. The fastener retention device 6 may therefore also be referred to as a fastener alignment device 6.

The fastener retention device 6 comprises a central longitudinal axis 25. The fastener retention device 6 comprises resilient arms 26. Each of the resilient arms 26 is configured to exert a biasing force on a rivet received by the fastener retention device 6 which is directed towards the central longitudinal axis 25. The axes defined by the direction of the biasing forces of each of the resilient arms 26 intersect generally on the central longitudinal axis 25 of the fastener retention device 6. The biasing forces provided by the resilient arms 26 allow the fastener retention device 6 to grip a rivet passing through the central bore 8 of the barrel 4, provide the rivet with the desired orientation and align the rivet within the central bore. Although the fastener retention device 6 is depicted as having three resilient arms 26, the fastener retention device 26 may have any suitable number of resilient arms 26. In general, a fastener retention device 6 with three resilient arms 26 is able to retain and align the fastener with sufficient support so as to ensure that the fastener is coaxial with the central bore 8 of the barrel 4 immediately before it is inserted into a workpiece. Additionally, a fastener retention device 6 with three resilient arms 26 is simple to manufacture and assemble into the nose assembly 2. A fastener retention device 6 with more than three resilient arms 26 may also be capable of ensuring that the fastener is coaxial with the central bore 8 of the barrel 4, but results in increased complexity of manufacture and assembly into the nose assembly 2. The fastener retention device 6 should be provided with at least two resilient arms 26, but if only two resilient arms were used then there would be a risk that the fastener would not be coaxial with the central bore 8 of the barrel 4 prior to insertion into a workpiece. If the fastener is not coaxial with the central bore 8 of the barrel 4, there is a risk that the fastener will damage the wall of the central bore 10 and/or that the fastener will be damaged by the wall of the central bore.

In the present embodiment the resilient arms 26 and hence fastener engaging portions 33 (see below) of each arm are equi-angularly spaced around the central axis. That is to say, in the present embodiment, there is approximately a 120° spacing between the location of one of the resilient arms and a resilient arm adjacent to it. In other embodiments this need not be the case. There may be any appropriate angular spacing between the resilient arms around the central axis.

In the depicted embodiment, each of the resilient arms 26 is connected to an annular member 28 at a proximal end 30. However, it will be appreciated that the annular member may be omitted. Where this is the case, the resilient arms 26 may instead be provided as separate components which are individually connected to the barrel 4. However, it will be appreciated that connecting the resilient arms 26 to the annular member 28, or other common fixing member (which includes an opening through which the fastener may pass), allows for easy assembly of the fastener retention device 6 into the nose assembly 2.

Each resilient arm 26 comprises a fastener engaging portion 33. In the depicted embodiment, the fastener engaging portion 33 is a fastener engaging member 34 which is formed separately from the resilient arm 26 and is attached to the resilient arm. The fastener engaging members 34 are attached to a distal end 32 of each resilient arm 26. In an alternative arrangement, the distal end 32 of each resilient arm 26 may be bent towards the central longitudinal axis 25 of the fastener retention device 6, thereby forming the fastener engaging portion 33 (i.e. the fastener engaging portion may be integrally formed with the resilient arm 26). Although in the depicted embodiment described below the fastener engaging portion 33 is a fastener engaging member 34, described and illustrated features may be implemented as a fastener engaging portion which is integrally formed with the resilient arm 26.

As can be seen, the resilient arms 26 are angled towards the central longitudinal axis 25. The fastener retention device 6 may be made of a type of steel, for example spring steel. Alternatively, the fastener retention device may be made of beryllium copper.

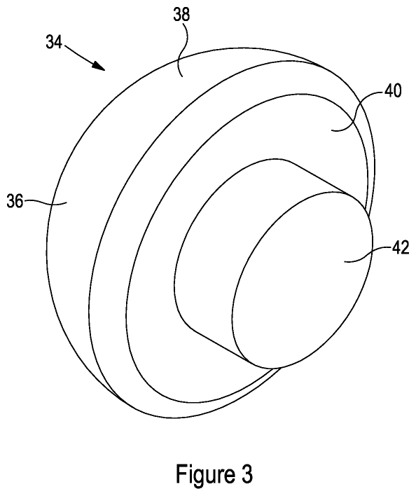

A fastener engaging member 34 is depicted in FIG. 3. Each of the fastener engaging members 34 may be identical. In the depicted embodiment, the fastener engaging member 34 comprises an offset hemisphere 36. The offset hemisphere 36 comprises a dome surface 38 and a circular surface 40. The fastener engaging member 34 also comprises a shaft 42 which projects from the circular surface 40 of the offset hemisphere 36. The shaft 42 is located generally centrally on the circular surface 40. It will be appreciated that the shaft 42 need not necessarily be located centrally on the circular surface 40. The fastener engaging members 34 may be made of metal, such as stainless steel or any other suitable material.

By “offset hemisphere” it is meant that the dome surface 38 of each of the fastener engaging members 34 is not a complete hemisphere. Instead, the dome surface 38 comprises less than half of a full hemisphere in the direction perpendicular to the circular surface 40. This advantageously avoids subjecting the resilient arms 26 to plastic deformation during assembly of the fastener retention device 6 on to the barrel 4 whilst allowing the fastener engaging members 34 to protrude in to the central bore 8 of the barrel 4.

Referring again to FIG. 2, each of the fastener engaging members 34 is received in an aperture 44 in a respective resilient arm 26. The fastener engaging members 34 are swaged to their respective resilient arms 26 in order to fix the fastener engaging members 34 with respect to their respective resilient arm 26. However, it will be appreciated that the fastener engaging members 34 may be fixed to their respective resilient arms 26 by any suitable means. For example, in a non-depicted embodiment, the fastener engaging members 34 may be adhered by virtue of a suitable adhesive to their respective resilient arms 26 (in which case the fastener engaging members 34 may or may not comprise shaft 42). Alternatively, in a non-depicted embodiment, the apertures 44 of the resilient arms 26 and the shafts 42 of the fastener engaging members 34 may be threaded, allowing the shafts 42 of the fastener engaging members 34 to be threaded to the apertures 44 of the resilient arms 26. This configuration may also apply in reverse, i.e. the resilient arms 26 may each comprise a threaded shaft which extends perpendicular to the respective resilient arm 26 and the circular surface 40 of the fastener engaging member 34 may comprise a threaded recess to receive the threaded shaft of the respective resilient arm 26. Alternatively, in a non-depicted embodiment, the fastener engaging members 34 may be welded to the resilient arms 26. The fastener engaging members 34 may be mounted to the resilient arms 26 in any appropriate manner.

Referring now to FIG. 4, the barrel 4 further comprises apertures 46. The apertures 46 may be located adjacent to the flat distal end 12 of the barrel 4. In the depicted embodiment, the apertures 46 are sized so as to receive the fastener engaging members 34 such that the fastener engaging members can project into the central bore 8 of the barrel 4. The apertures 46 receive the fastener engaging members 34 via a clearance fit. Therefore, it will be appreciated that the fastener engaging members 34 substantially close the apertures 46, but a gap between the fastener engaging members 34 and a respective aperture may be provided. Advantageously, this substantially prevents any debris from exiting the barrel 4 via the apertures 46. It will also be appreciated that the number of apertures 46 should correspond to the number of resilient arms 26.

The barrel 4 further comprises recesses 48. Each of the recesses 48 extends to a respective aperture 46. Each of the recesses 48 comprises a recess surface 49. The recesses 48 are formed in the external surface 51 of the distal section 14 of the barrel 4. The recesses 48 extend radially into the external surface 51 of the barrel 4. It follows that the recess surfaces 49 form part of the external surface 51 of the barrel 4. Each of the recesses 48 comprise a rest surface 50. It follows that since the recesses 48 are formed in the external surface 51 of the barrel 4, the rest surfaces 50 are also external surfaces. It will be appreciated that the number of recesses 48 may correspond to the number of resilient arms 26.

When the nose assembly 2 has been assembled, as is shown in FIG. 1, and the fastener retention device 6 is in a rest state, the resilient arms 26 rest against a respective rest surface 50. The rest surface 50 defines the position of the resilient arms 26 when the fastener retention device 6 is in the rest state (i.e. when a rivet is not engaged by the fastener retention device). The angle between the resilient arms 26 and an axis perpendicular to the central axis 10 may be between 70 and 80 degrees. In particular, the angle between the resilient arms 26 and an axis perpendicular to the central axis 10 may be between 72.5 and 77.5 degrees. In particular, the angle between the resilient arms 26 and an axis perpendicular to the central axis 10 may be around 75 degrees.

In the depicted embodiment, the rest surface 50 is depicted as a planar surface. However, the rest surface 50 may be any suitable geometry provided that the resilient arms 26 are able to rest against it at a suitable position. The barrel 4 may be manufactured via any suitable process. For example, the barrel 4 may be machined from solid. Alternatively, the barrel 4 may be manufactured via 3D printing.

The barrel 4 need not be provided with recesses 48. Instead, in a non-depicted embodiment, the barrel 4 could comprise an axial section of reduced outside diameter which allows the resilient arms 26 to extend towards the central axis 10 of the central bore 8 of the barrel 4. The reduced diameter section may be of constant diameter, or be of varying outside diameter such that the shape of the external surface 51 of the barrel 4 corresponds to the shape of the resilient arms 26 when the resilient arms are in the rest state. It is preferred to provide recesses 48 because the recesses also ensure the circumferential position of each of the resilient arms 26. In addition, providing recesses 48 requires the removal of less material compared to providing an axial section of reduced diameter. This improves the robustness of the barrel 4 which is beneficial due to the loading experienced by the barrel during the riveting process.

In order to assemble the fastener retention device 6 on to the barrel 4, the resilient arms 26 should be deformed such that they flex radially outwardly. This can be done either manually or using machinery. The resilient arms 26 should be deformed such that the radial distance from the central longitudinal axis 25 of the fastener retention device 6 to the radially innermost point of the distal end 32 of each of the resilient arms 26 is greater than the radial distance from the central axis 10 of the central bore 8 of the barrel 4 to the radially innermost point of the recess surface 49. This allows each of the resilient arms 26 to be received by a respective recess 48 when the central longitudinal axis 25 of the fastener retention device 6 is coaxial with the central axis 10 of the bore 8 of the barrel 4. The fastener retention device 6 may then be axially translated with respect to the barrel 4, or vice versa, such that the recesses 48 receive a respective resilient arm 26 until the fastener engaging members 34 are received by a respective aperture 46.

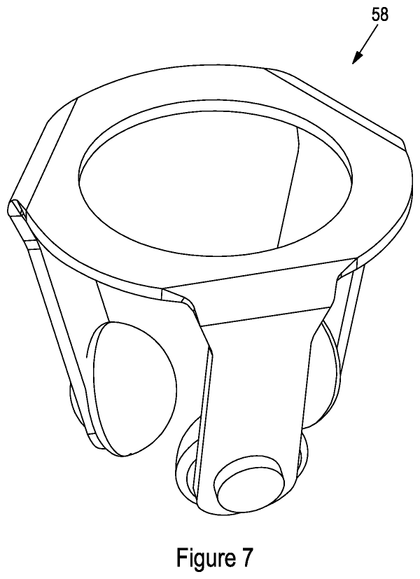

FIG. 7 depicts an alternative embodiment of a fastener retention device 58. The fastener retention device 58 is generally identical to the fastener retention device 26 discussed above. The fastener retention device 58 operates in the same way as fastener retention device 26. The fastener retention devices 26, 58 differ in their axial length. It may be desirable to provide a barrel 4 with a shortened distal section 14. If a barrel 4 with a shortened distal section 14 is used, a shortened fastener retention device 58 must also be used. This is to ensure that the apertures 46 of the barrel 4 are spaced apart from the flat distal end 12 of the barrel by the same distance regardless of the length of the distal section 14 of the barrel. The length of the barrel may be chosen to be any appropriate length given the particular application of the fastener retention device. For example, the barrel length may be determined by the stroke of the rivet setter and/or the degree of access available to the workpiece.

Referring now to FIGS. 1, 5 and 6, use of the nose assembly 2 will now be discussed. The rivet 52 comprises a shank 54 and a head 56. The head 56 comprises an underside 53. In the depicted embodiment, the underside 53 of the head 56 is circular in cross-section. Although a hollow rivet 52 is depicted, the present invention is suitable for use with any self-piercing rivet, e.g. a semi-hollow self-piercing rivet (or other form of fastener). As noted above, rivets 52 are either provided for engagement by the actuator 19 under air or gas pressure, or they presented at the top of the nose assembly 2 by a tape feed. As also noted above, once the rivet 52 has been engaged by the actuator 19, the present invention operates in generally the same way regardless of the method by which the rivets are provided.

When the nose assembly 2 is positioned such that a rivet 52 may be driven into the workpiece at a desired location, the rivet is engaged by the actuator 19. The actuator 19 travels towards the workpiece at a speed of up to 350 mm/s. Whether or not the actuator 19 maintains contact with the rivet 52 as it travels through the bore 20 of the adaptor 18 and the bore 8 of the barrel 4 is determined by the orientation of the nose assembly 2. For example, in a first condition, if the nose assembly 2 is orientated such that the rivet 52 and actuator 19 travel in the direction of gravity, the rivet will be engaged by the advancing actuator which will accelerate the rivet to the speed of the actuator 19. Once the speed of the rivet 52 matches the speed of the actuator 19 (which happens near instantaneously), the rivet will then further accelerate by virtue of gravity, and therefore may lose contact with the actuator 19. Alternatively, in a second condition, if the nose assembly 2 is orientated such that the rivet 52 travels in the opposite direction to gravity, the actuator 19 will maintain contact with the rivet during the riveting process by virtue of gravity urging the rivet into contact with the actuator. It will be appreciated that orientations between the orientations discussed above may result in the actuator 19 maintaining or losing contact with the rivet 52 depending on the angle of the nose assembly (i.e. of the longitudinal axis 10 of the central bore 8 of the barrel) with respect to the direction of gravity. In addition the orientation of nose assembly with respect to gravity and/or the orientation of a rivet relative to the bore 20 of the adaptor 18 and the bore 8 of the barrel 4 may affect the extent to which a rivet moving through the bores 20, 8 contacts the respective walls of each bore. A greater extent of contact between the rivet and a wall of a bore will result in a greater extent of contact between the rivet and the actuator as the rivet is pushed through the bores. However, such contact may have an adverse effect by causing increased wear of the walls.

FIG. 1 shows the nose assembly 2 before the rivet has reached the fastener retention device 6. This state is referred to as the rest state, as discussed above. This is because the rivet 52 has not yet engaged, and therefore caused deformation of, the fastener retention device 6.

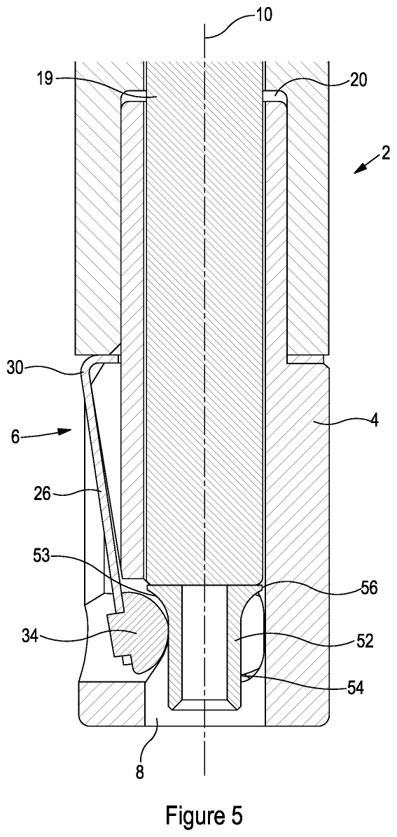

With the resilient arms 26 in the rest state, which is shown in FIG. 1, the radially innermost points of each of the fastener engaging members 34 are equidistant from the central axis 10 of the central bore 8 of the barrel 4. The radial distance from the central axis 10 to the radially innermost point of the fastener engaging members 34, should be equal to or less than the outside diameter of the shank 54 of the rivet 52. Specifically, if the rivet (and hence resilient arms) is (are) in the intermediate state as shown in FIG. 5, the radial distance from the central axis 10 to the radially innermost point of the fastener engaging members 34 may be substantially equal to the outside radius of the shank 54 of the rivet 52. If the resilient arms are in the rest state as shown in FIG. 1, the radial distance from the central axis 10 to the radially innermost point of the fastener engaging members 34 may be less than the outside radius of the shank 54 of the rivet 52. For example, the ratio between the radial distance from the central axis 10 to the radially innermost point of the fastener engaging members 34 and the outside radius of the shank 54 of the rivet 52 may be between about 0.5:1 and about 1:1, and, preferably between about 0.75:1 and about 1:1.

Once the rivet 52 reaches the fastener retention device 6, the rivet 52 is engaged by the fastener engaging members 34. This results in the resilient arms 26 being deflected outwards to an intermediate state. FIG. 5 depicts the fastener retention device 6 in the intermediate state. To transition from the rest state to the intermediate state, the resilient arms 26 are flexed (or deflected) outwardly (with respect to the central axis). In the intermediate state, the distance from the central axis 10 of the central bore 8 of the barrel 4 to the radially innermost point of the fastener engaging members 34 is equal to the outside radius of the shaft 54 of the rivet 52. As discussed above, in the first condition the actuator 19 may lose contact with the rivet 52 as it advances towards the workpiece or in the second condition the actuator 19 maintains contact with the rivet 52 as it advances towards the workpiece.

For the first condition, the rivet 52 may deflect the resilient arms 26 to the intermediate state. While in the intermediate state, the fastener retention device acts to retain the rivet 52 until the actuator 19 re-engages the head 56 of the rivet 52. Additionally, the fastener retention device 6 also acts so as to align the rivet 52 in the central bore 8 of the barrel 4. The momentum of the rivet 52 (whilst out of contact with the actuator) is not sufficient to deflect the resilient arms 26 to the extent that the head 56 of the rivet is able to pass through the fastener retention device 6. The force required to allow the rivet to pass through the fastener retention device may be less than 50N. For example, the force may be 40N or any other appropriate force. It will be appreciated that in this condition, depending upon the alignment of the rivet 52 with the central bore 8 of the barrel 4, the momentum of the rivet, and the force required to deflect the resilient arms outwards to the required extent, the rivet 52 may not deflect the resilient arms 26 to the intermediate state and may instead simply rest on the fastener engaging members 34. In this case, the rivet 52 will rest on the fastener engaging members 34 until the actuator 19 re-engages the head 56 of the rivet. Once the rivet 52 is re-engaged it travels towards the workpiece, and the resilient arms 26 will be deflected to the intermediate state.

In the second above-noted condition, wherein the actuator 19 maintains contact with the rivet 52 as it advances towards the workpiece, the rivet 52 will be engaged by the fastener engaging members 34 and the resilient arms 26 will transition from the rest state to the intermediate state.

Regardless of whether the rivet ends up being held by the fastener retention device with the arms in the intermediate state, the rivet having previously been in the first or second condition mentioned above, when the rivet 52 is engaged by the fastener engaging members 34 and the resilient arms 26 are transitioned to the intermediate state, the rivet is aligned with the central bore 8 of the barrel 4. This is by virtue of the biasing force provided by the resilient arms 26. In other words, the shank 54 of the rivet 52 is made to be coaxial with the longitudinal axis 10 of the central bore 8 of the barrel 4. In some instances, prior to the intermediate state, the shank 54 of the rivet may be out of alignment with the longitudinal axis 10 of the central bore 8 of the barrel 4. Aligning the rivet 52 with the longitudinal axis 10 of the central bore 8 of the barrel 4 ensures that the rivet forms a good connection in the workpiece when the rivet is urged into the workpiece by the actuator.

It will be appreciated that the rivet 52 need not necessarily bias the resilient arms 26 in order to be retained and aligned by the fastener retention device 6. Instead, the radially innermost point of each of the resilient arms 26 could be radially outwards of the radially outermost point of the shank 54 of the rivet 52 and radially inwards of the radially outermost point of the head 56 of the rivet 52. Therefore, when the rivet 52 passes through the central bore 8 of the barrel 4, the underside 53 of the head 56 of the rivet directly engages the fastener engaging members 34 in order to retain and align the rivet. This method of retaining and aligning the rivet 52 is referred to as head gripping. It will be appreciated that in this case it is the weight of the rivet 52 which at least in part aligns the rivet with the central axis 10 of the central bore 8 of the barrel 4. In addition, the deflection of the resilient arms 26 beyond their intermediate position when the underside 53 of the head 56 is engaged by the fastener engaging members 34 (in absence of the action of the actuator) is negligible. Furthermore, when the head of the rivet is engaged by the actuator, the force exerted by the actuator on the rivet (in the direction of the workpiece) in combination with the radially inwards force exerted by the resilient arms on the rivet may also, at least in part, align the rivet with the central axis 10 of the central bore 8 of the barrel 4.

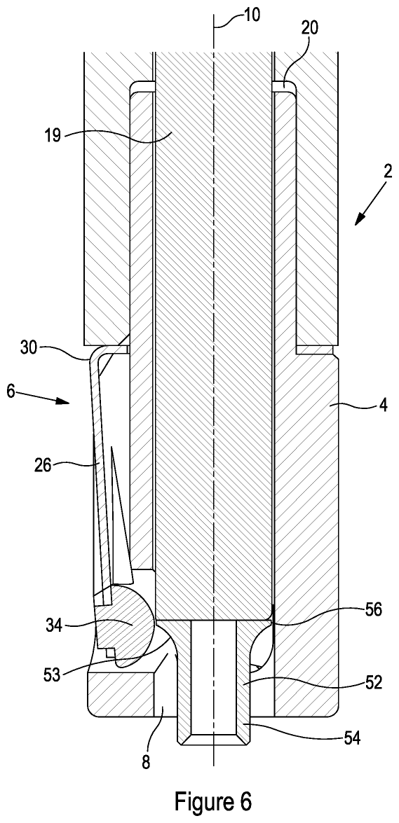

As the actuator 19 advances through the central bore 8 of the barrel 4 whilst in contact with the rivet, the fastener retention device 6 is deflected to a maximum deflection state. FIG. 6 depicts the fastener in the maximum deflection state. In the maximum deflection state, the resilient arms 26 are at a maximum deflection. Maximum deflection is achieved when the radially outermost point of the rivet 52 engages the fastener engaging members 34 (and, in particular, a tip of each fastener engaging member). The radially outermost point of the rivet 52 will typically be at the head 56 of the rivet. Generally speaking, the radially innermost point of the fastener engaging members 34 (which may be a tip of a fastener engaging member) cannot be outwardly deflected past the surface of the wall that defines the bore. This in turn may define the maximum deflection of the resilient arms 26.

As can be seen in FIG. 6, at maximum deflection, no part of the fastener retention device 6 passes beyond the periphery of the nose assembly 2. It is particularly beneficial that no part of the fastener retention device 6 passes beyond the periphery of the barrel 4. Nose assemblies 2 have a required working space which is the maximum space occupied by the nose assembly at any point during operation of the nose assembly. Reducing the required working space of a nose assembly 2 allows the nose assembly to access regions of a workpiece that may otherwise be inaccessible, i.e. if using a nose assembly with a larger required working space. Therefore, it will be appreciated that if no part of the fastener retention 6 device passes beyond the periphery of the nose assembly 2 the required working space of the nose assembly 2 is minimised. That is, the working space of the nose assembly is simply defined by the outside diameter of the barrel 4. Therefore, the fastener retention device 6 does not increase the effective diameter of the barrel. The effective diameter of the barrel 4 may be understood to mean the largest diameter of the barrel at any point during operation of the nose assembly 2.

Optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate. Although the invention has been described above with regard to a rivet, the invention may also be applied to any fastener. For example, the invention may be used with screws or bolts, among other things, as will be appreciated by those skilled in the art.

1. A fastener delivery apparatus comprising:
a nose assembly configured to convey a fastener towards a workpiece, the nose assembly comprising a barrel and a fastener alignment device;
wherein the barrel comprises a bore having a longitudinal axis and a distal end for engaging the workpiece;
an actuator configured to urge the fastener through the bore;
wherein the fastener alignment device comprises a plurality of resilient arms which extend towards the distal end of the barrel;
wherein at least part of each of the plurality of resilient arms projects into the bore via apertures in the barrel;
wherein the plurality of resilient arms are biased radially inwards to engage the fastener; and
wherein the resilient arms are configured such that at a maximum deflection, the resilient arms do not pass beyond the periphery of the barrel.

2. The fastener delivery apparatus of claim 1, wherein, in a rest state, at least part of the plurality of resilient arms are located against an external surface of the barrel thereby defining the position of the plurality of resilient arms when the plurality of resilient arms are in the rest state.

3. The fastener delivery apparatus of claim 1, wherein the nose assembly comprises an adaptor which receives the barrel, and wherein a portion of the fastener alignment device is held between the barrel and the adaptor.

4. The fastener delivery apparatus of claim 1, wherein the inclusive angle of the resilient arms with respect to an axis perpendicular to the longitudinal axis at the maximum deflection is less than 90 degrees.

5. The fastener delivery apparatus of claim 1, wherein at zero deflection the angle of the resilient arms with respect to an axis perpendicular to the longitudinal axis of the barrel is between about 76 degrees and about 81.5 degrees.

6. The fastener delivery apparatus of claim 1, wherein the fastener alignment device further comprises an annular member and wherein each of the plurality of resilient arms are connected to the annular member.

7. The fastener delivery apparatus of claim 1, wherein the resilient arms deflect radially outwards when the fastener is urged through the bore by the actuator and allow passage of the fastener out of the bore.

8. The fastener delivery apparatus of claim 1, wherein the fastener alignment device further comprises a plurality of fastener engaging members which are affixed to distal ends of each of the plurality of resilient arms.

9. The fastener delivery apparatus of claim 8, wherein the fastener engaging members comprise offset hemispheres.

10. (canceled)

11. The fastener delivery apparatus of claim 1, wherein the plurality of resilient arms comprises three resilient arms.

12. A method of delivering a fastener to a workpiece comprising:
moving a fastener through a bore of a barrel of a fastener delivery apparatus;
gripping at least part of the fastener with a fastener alignment device;
wherein the fastener alignment device comprises a plurality of resilient arms which extend towards a distal end of the barrel;
wherein at least part of each of the plurality of resilient arms project into the bore of the barrel via apertures in the barrel; the method further comprising
driving the fastener with an actuator;
wherein driving of the fastener results in the resilient arms being deflected radially outwards so as to permit passage of the fastener past the fastener alignment device and out of the barrel;
wherein at maximum deflection, the plurality of the resilient arms do not pass beyond the periphery of the barrel.

13. The method of claim 11, wherein, in a rest state, at least part of the plurality of resilient arms are located against an external surface of the barrel thereby defining the position of the plurality of resilient arms when the plurality of resilient arms are in the rest state.

14. The method of claim 11, wherein the nose assembly comprises an adaptor which receives the barrel, and wherein a portion of the fastener alignment device is held between the barrel and the adaptor.

15. The method of claim 11, wherein the inclusive angle of the resilient arms with respect to an axis perpendicular to the longitudinal axis at the maximum deflection is less than 90 degrees.

16. The method of claim 11, wherein at zero deflection the angle of the resilient arms with respect to an axis perpendicular to the longitudinal axis of the barrel is between about 76 degrees and about 81.5 degrees.

17. The method of claim 11, wherein the fastener alignment device further comprises an annular member and wherein each of the plurality of resilient arms are connected to the annular member.

18. The method of claim 11, wherein the resilient arms deflect radially outwards when the fastener is urged through the bore by the actuator and allow passage of the fastener out of the bore.

19. The method of claim 11, wherein the fastener alignment device further comprises a plurality of fastener engaging members which are affixed to distal ends of each of the plurality of resilient arms.

20. The method of claim 18, wherein the fastener engaging members comprise offset hemispheres.

21. (canceled)

22. The method of claim 11, wherein the plurality of resilient arms comprises three resilient arms.
